(19) United States
(12) Patent Application Publication
(10) Pub. No.: US 2008/0236961 A1
(43) Pub. Date: Oct. 2, 2008

(54) VEHICLE-USE DISC BRAKE

(76) Inventor: Hidetoshi Toyoda, Saitama (JP)

Correspondence Address: BIRCH STEWART KOLASCH & BIRCH, PO BOX 747, FALLS CHURCH, VA, 22040-0747, US

(21) Appl. No.: 12/053,723

(22) Filed: Mar. 24, 2008

(30) Foreign Application Priority Data
Mar. 27, 2007 (JP) 2007-081245

(51) Int. Cl. F16D 65/14

(52) U.S. Cl. 188/106 R

(57) ABSTRACT

A disc brake in which three pistons are arranged respectively on both sides of a brake disc to miniaturize the disc brake and to enhance the merchantability of a motorcycle by simplifying the appearance shape of the disc brake. A first oil passage provides a communication with first and second oil pressure chambers respectively facing back surfaces of the first and second pistons. A second oil passage provides a communication with third, fourth, fifth and sixth oil pressure chambers respectively facing back surfaces of the third to sixth pistons. The first and second oil passages are formed inside of a caliper body.

### CROSS-REFERENCE TO RELATED APPLICATIONS

The present application claims priority under 35 USC 119 to Japanese Patent Application No. 2007-081245 filed on Mar. 27, 2007 the entire contents of which are hereby incorporated by reference.

### BACKGROUND OF THE INVENTION

1. Field of the Invention

The present invention relates to a vehicle-use disc brake which includes a caliper body having first and second bodies which sandwich a pair of pads arranged on both sides of a brake disc rotated with a wheel between the first and second bodies and the brake disc. First and second pistons are capable of pushing both pads toward the brake-disc side and are fitted in the first and second bodies coaxially and slidably. Third and fourth pistons are capable of pushing both pads toward the brake-disc side and are fitted in the first and second bodies coaxially and slidably on one sides of the first and second pistons along the circumferential direction of the brake disc. Fifth and sixth pistons are capable of pushing both pads toward the brake-disc side and are fitted in the first and second bodies coaxially and slidably on another sides of the first and second pistons along the circumferential direction of the brake disc. The first and second pistons are interlockingly operated with each other, and the third to sixth pistons are interlockingly operated.

2. Description of Background Art

A vehicle-use disc brake is disclosed in Japanese Patent No. 3713857 and JP-A-2005-121174.

Such a disc brake is used, for example, as a front and rear interlocking brake device of a motorcycle or the like. In the brake device which arranges three pistons on each side of the brake disc, the pistons which are arranged at a center portion along the circumferential direction of the disc brake are interlockingly operated and the remaining pistons are interlockingly operated. Thus, the brake effect can be increased. Accordingly, cylinder holes which allow the respective pistons to be slidably fitted therein and are formed in a caliper body can make diameters thereof small thus realizing the miniaturization of a size of the caliper body in the radial direction of the disc brake. However, depending on the oil passage structure which makes oil pressure chambers communicate with each other for operating the pistons which are interlocked on both sides of the brake disc, the disc brake has a possibility of not only making the caliper body large-sized but also making an appearance shape of the disc brake complicated thus lowering merchantability of a motorcycle.

### SUMMARY AND OBJECTS OF THE INVENTION

It is an object of an embodiment of the present invention to provide a vehicle-use disc brake having an oil passage structure which can realize the miniaturization of a disc brake and, at the same time, can realize the enhancement of merchantability of a motorcycle by simplifying an appearance shape of the disc brake.

According to an embodiment of the present invention, a vehicle-use disc brake includes a caliper body having first and second bodies which sandwich a pair of pads arranged on both sides of a brake disc rotated with a wheel between the first and second bodies and the brake disc. First and second pistons are capable of pushing both pads toward the brake-disc side and are fitted in the first and second bodies coaxially and slidably. Third and fourth pistons which are capable of pushing both pads toward the brake-disc side and are fitted in the first and second bodies coaxially and slidably on one sides of the first and second pistons along the circumferential direction of the brake disc. Fifth and sixth pistons are capable of pushing both pads toward the brake-disc side and are fitted in the first and second bodies coaxially and slidably on another sides of the first and second pistons along the circumferential direction of the brake disc. The first and second pistons are interlockingly operated with each other and the third to sixth pistons are interlockingly operated. Thus, inside the caliper body, a first oil passage is formed to make first and second oil pressure chambers respectively facing back surfaces of the first and second pistons communicate with each other. In addition, a second oil passage is formed to make third, fourth, fifth and sixth oil pressure chambers respectively facing back surfaces of the third to sixth pistons communicate with each other.

According to an embodiment of the present invention, the caliper body integrally includes a first connection portion for connecting center portions of the first and second bodies along the circumferential direction of the brake disc and strides over the brake disc and second and third connection portions which connect both end portions of the first and second bodies along the circumferential direction of the brake disc and stride over the brake disc. The first oil passage is formed in the first body, the second body and the first connection portion.

According to an embodiment of the present invention, the second oil passage is formed of a first body side oil passage formed in the first body to make the third and fifth oil pressure chambers communicate with each other. A second body side oil passage is formed in the second body to make the fourth and sixth oil pressure chambers communicate with each other. A communication oil passage is formed in either one of the second and third connection portions to connect the first body side oil passage and the second body side oil passage with each other.

According to an embodiment of the present invention, the first body, a first cylinder hole includes a bottom for allowing the first piston to be slidably fitted therein and includes an outer end thereof closed by an end wall which forms the first oil pressure chamber between the first piston and the end wall. Third and fifth cylinder holes include bottoms which are formed longer than the first cylinder hole and are arranged on both sides of the first cylinder hole for allowing the third and fifth pistons to be respectively slidably fitted therein, and have outer ends thereof closed by end walls which respectively form the third and fifth oil pressure chambers that are formed between the third and fifth pistons and the end walls. In the second body, second, fourth and sixth cylinder holes are formed having both ends thereof opened allow the second, fourth and sixth pistons to be slidably fitted therein. Closing members for closing outer ends of the second, fourth and sixth cylinder holes are mounted on the second body such that the second, fourth and sixth oil pressure chambers are formed between the second, fourth and sixth pistons and the closing members. The first body side oil passage of the second oil passage is formed in the first body in a linearly extending manner along an outside of the first oil pressure chamber along the axial direction of the first cylinder hole to make the third and fifth oil pressure chambers communicate with each other. The second body side oil passage of the second oil passage is formed in the second body in a linearly extending manner along an outside or inside of the closing member of the second cylinder hole along the radial direction of the brake disc to make the fourth and sixth oil pressure chambers communicate with each other

According to an embodiment of the present invention, the communication oil passage of the second oil passage is formed in either one of the second and third connection portions to connect the first and second body side oil passages with each other along an outside of a mounting hole for mounting the caliper body on a vehicle body side.

According to an embodiment of the present invention, the disc brake is mounted on a front wheel of a motorcycle such that a first master cylinder which generates an oil pressure in response to a manipulation of a first brake manipulation member is connected to the second oil passage. In addition, a second master cylinder which generates an oil pressure in response to a manipulation of a second brake manipulation member is connected to the first oil passage.

A brake lever 21 of an embodiment of the present invention corresponds to the first brake manipulation member. A brake pedal 23 of the embodiment of the present invention corresponds to the second brake manipulation member.

According to an embodiment of the present invention, the first oil passage which makes the first and second oil pressure chambers communicate with each other and the second oil passage which makes the third, fourth, fifth and sixth oil pressure chambers communicate with each other are formed in the inside of the caliper body. Thus, it is unnecessary to connect the first and second bodies with a conduit which is arranged outside the caliper body so as to introduce an oil pressure whereby the miniaturization of the disc brake can be realized. In addition, the merchantability of the motorcycle can be enhanced due to the simplification of the appearance and shape of the disc brake.

According to an embodiment of the present invention, the caliper body is integrally formed of the first connection portion which connects center portions of the first and second bodies along the circumferential direction of the brake disc and strides over the disc brake. In addition, the second and third connection portions connect the first and second bodies and stride over the disc brake. Thus, the number of parts can be decreased and, at the same time, the time and effort necessary for assembling the caliper body can be reduced. In addition, the caliper body can be of a light-weight. Further, by effectively making use of the first connection portion for connecting the center portions of the first and second bodies along the circumferential direction of the brake disc, it is possible to form the first oil passage which makes the first and second oil pressure chambers arranged in the center portions of the first and second bodies along the circumferential direction of the brake disc communicate with each other.

According to an embodiment of the present invention, the second oil passage is formed of the first body side oil passage formed in the first body to make the third and fourth oil pressure chambers communicate with each other. The second body side oil passage is formed in the second body to make the fourth and sixth oil pressure chambers communicate with each other. The communication oil passage which is formed in either one of the second and third connection portions connects the first body side oil passage and the second body side oil passage with each other. Due to such a construction, by effectively making use of one of the second and third connection portions, it is possible to form the second oil passage having an approximately U-shape in a plan view in the inside of the caliper body.

According to an embodiment of the present invention, out of the second oil passage which makes the third to sixth oil pressure chambers communicate with each other, the first body side oil passage formed in the first body makes the third and fifth oil pressure chambers communicate with each other along an outside of the first cylinder hole that is shorter than the third and fifth cylinder holes. Further, out of the second oil passage, the second body side oil passage formed in the second body makes the fourth and sixth oil pressure chambers communicate with each other along an outside or inside of the closing member in the radial direction of the brake disc to obviate interference with the closing member which closes the outer end of the second cylinder hole. Due to such a construction, it is possible to obviate the large-sizing of the first and second bodies for forming the first body side oil passage and the second body side oil passage.

According to an embodiment of the present invention, the communication oil passage which connects the first and second body side oil passages with each other is formed in either one of the second and third connection portions along an outside of the mounting hole for mounting the caliper body on the vehicle body side. Due to such a construction, a conduit which is arranged outside the caliper body for connecting the first and second body side oil passages becomes unnecessary thus increasing merchantability of the motorcycle by simplifying an appearance and shape of the caliper body.

According to an embodiment of the present invention, the disc brake of the present invention can be preferably used in a front or a rear interlocking brake device of the motorcycle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a view showing the construction of a portion of a motorcycle-use brake device;

FIG. 2 is a plan view showing a disc brake of the present invention;

FIG. 3 is a view as viewed in the direction of an arrow 3 in FIG. 2;

FIG. 4 is a view as viewed in the direction of an arrow 4 in FIG. 2;

FIG. 5 is a cross-sectional view taken along a line 5-5 in FIG. 3; and

FIG. 6 is a cross-sectional view taken along a line 6-6 in FIG. 3.

### DETAILED DESCRIPTION OF THE PREFERRED EMBODIMENTS

Hereinafter, a mode for carrying out the present invention is explained in conjunction with one embodiment of the present invention shown in the attached drawings.

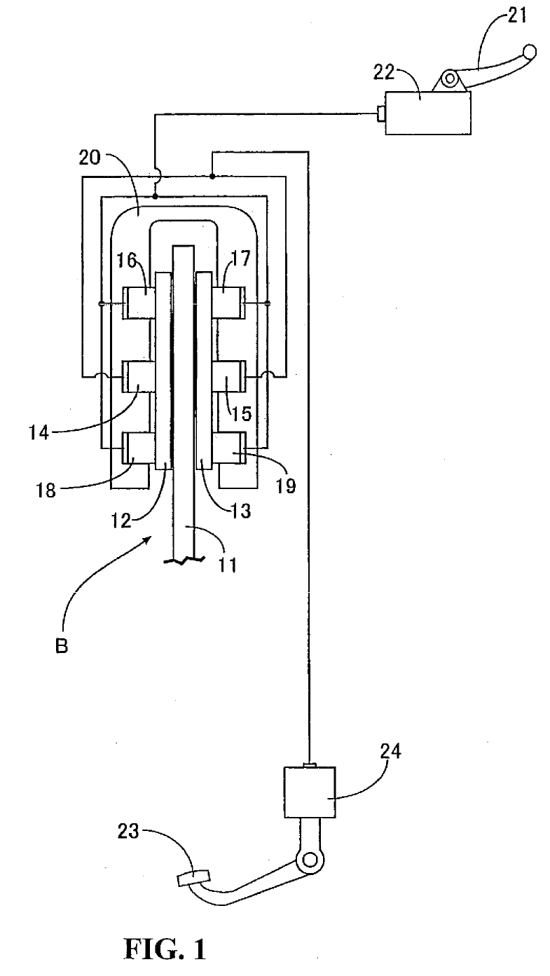

As illustrated in FIG. 1, a disc brake B according to the present invention is mounted on a front wheel (not shown in the drawing) of a motorcycle. The disc brake B includes a brake disc 11 which is rotatable with the front wheel, first and second pads 12, 13 which are arranged on both sides of the brake disc 11. A caliper body 20 is arranged astride the brake disc 11 with first, third and fifth pistons 14, 16, 18 which are capable of pushing the first pad 12 toward a brake-disc-11 side and second, fourth and sixth pistons 15, 17, 19 which are capable of pushing the second pad 13 toward the brake-disc-11 side are fitted slidably. When an oil pressure is outputted from a first master cylinder 22 which outputs the oil pressure in response to a manipulation of a brake lever 21 which constitutes a first brake manipulation member, the third to sixth pistons 16 to 19 are operated interlockingly with each other so as to push the first and second pads 12, 13 toward the brake-disc-11 side, while when an oil pressure is outputted from a second master cylinder 24 which outputs the oil pressure in response to a manipulation of a brake pedal 23 which constitutes a second brake manipulation member, the first and second pistons 14, 15 are operated interlockingly with each other so as to push the first and second pads 12, 13 toward a brake-disc-11 side.

Further, the disc brake B is preferably applicable to a radial-mount-type disc brake which fixes the mounting direction of the caliper body 20 in the radial direction of a wheel by taking into consideration the improvement of rigidity, detachability and maintainability of the caliper body 20.

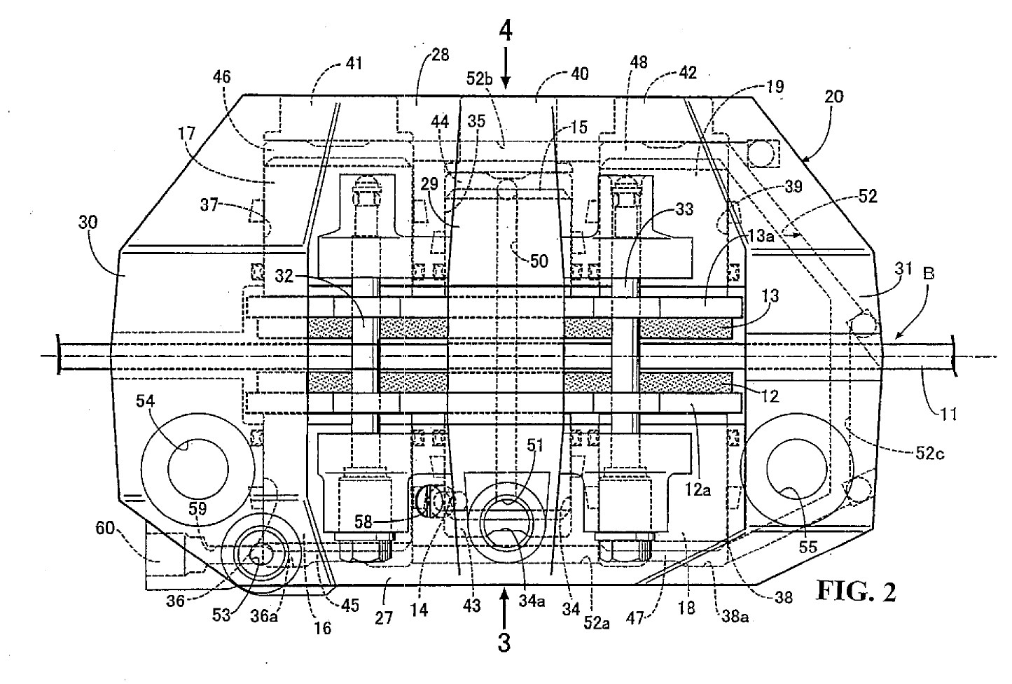

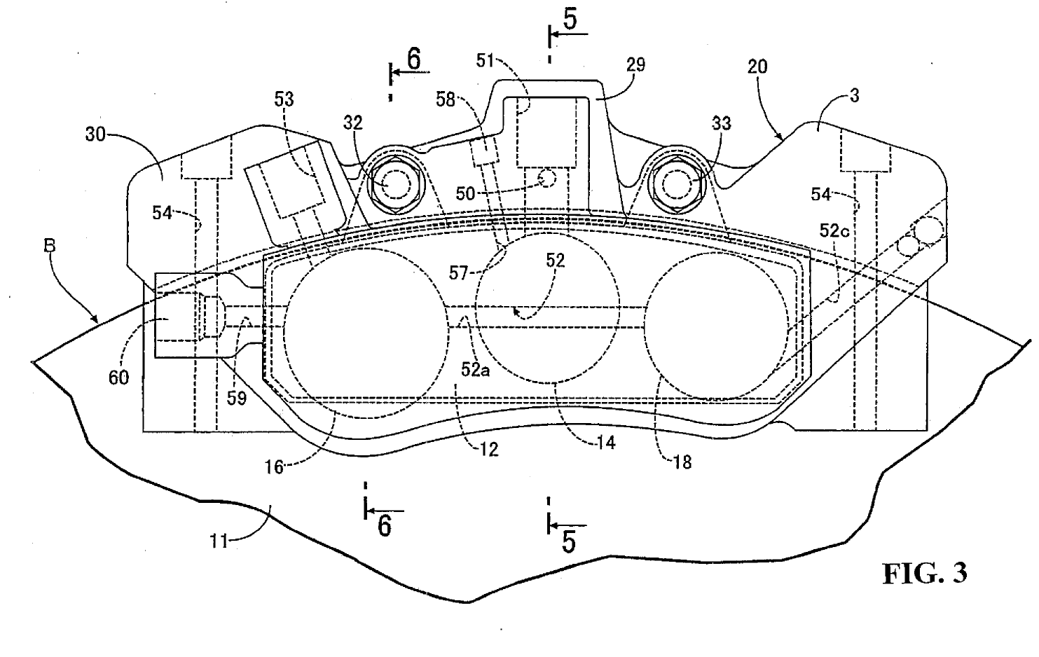

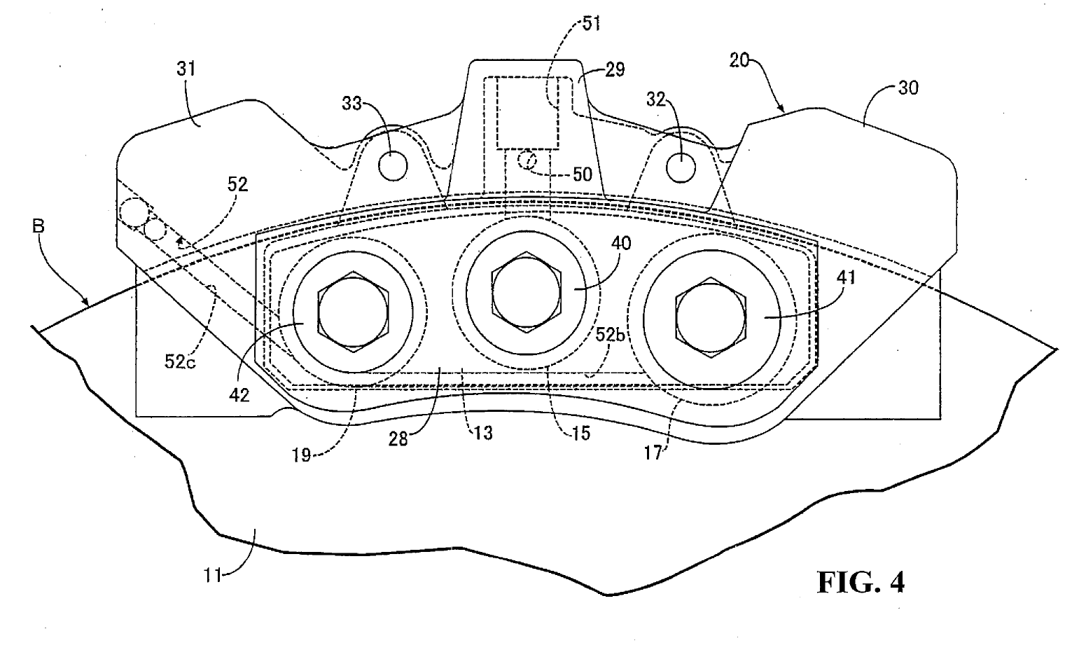

In FIGS. 2 to 4, the caliper body 20 is integrally formed of a first body 27 arranged at a position where the first pad 12 is sandwiched between the first body 27 and the brake disc 11. A second body 28 is arranged at a position where the second pad 13 is sandwiched between the second body 28 and the brake disc 11. A first connection portion 29 connects center portions of the first and second bodies 27, 28 along the circumferential direction of the brake disc II and strides over the brake disc 11. Second and third connection portions 30, 31 connect both end portions of the first and second bodies 27, 28 along the circumferential direction of the brake disc 11 and stride over the brake disc 11.

Back plates 12a, 13a of the first and second pads 12, 13 are slidably supported on a hanger pin 32 which is arranged between the first connection portion 29 and the second connection portion 30 and extends between the first and second bodies 27, 28. A hanger pin 33 is arranged between the first and third connection portions 29, 31 and extends between the first and second bodies 27, 28 in the axial direction of the brake disc 11.

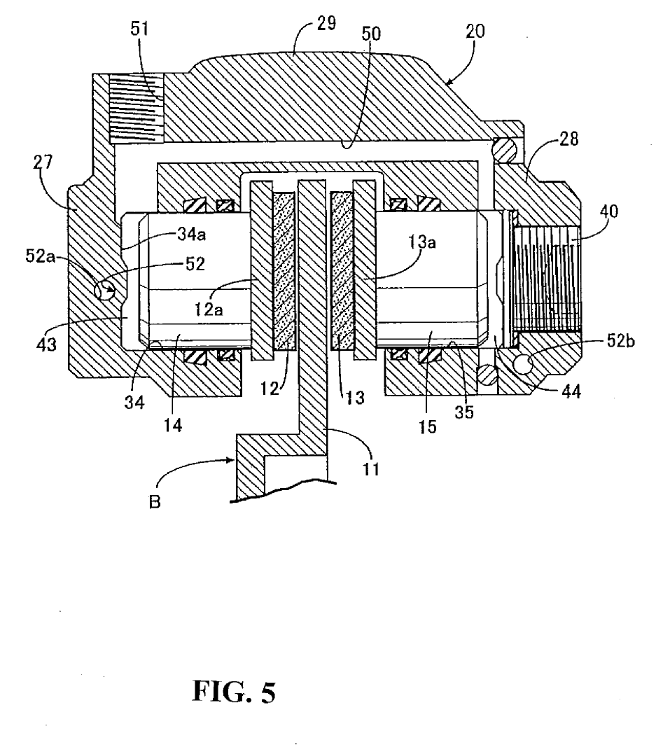

To explain this embodiment also in conjunction with FIG. 5 in the first body 27, a first cylinder hole 34 is formed that allows the first piston 14 capable of pushing the first pad 12 toward the brake-disc-11 side to be slidably fitted therein and has an outer end thereof closed by an end wall. In the second body 28, a second cylinder hole 35 is formed which allows the second piston 15 capable of pushing the second pad 13 toward the brake-disc-11 side to be slidably fitted therein and has both ends thereof opened coaxially with the first cylinder hole 34. An outer end of the second cylinder hole 35 is fluid-tightly closed by a first closing member 40 which is threadedly engaged with the second body 28, for example. Further, a first oil pressure chamber 43 is formed between an end wall 34a of the first cylinder hole 34 and the first piston 14, and a second oil pressure chamber 44 is formed between the second piston 15 and the first closing member 40.

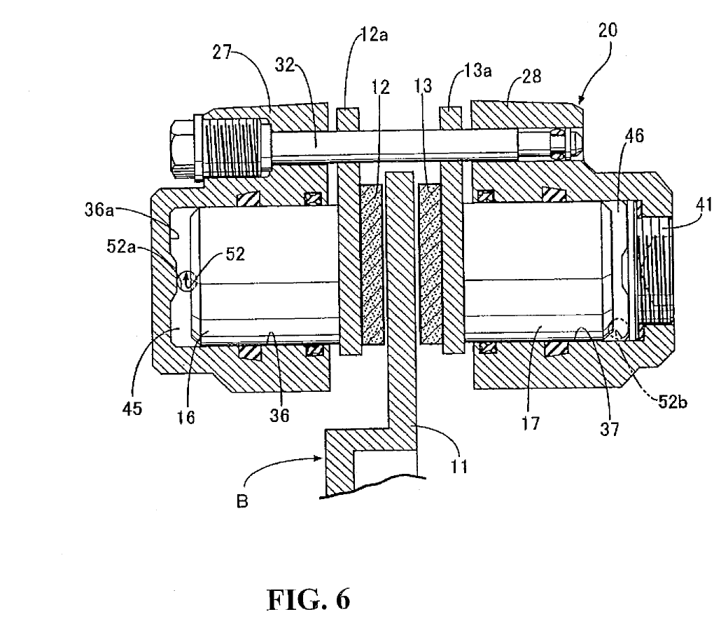

To explain this embodiment also in conjunction with FIG. 6, in the first body 27, third and fifth cylinder holes 36, 38 are formed having bottoms that allow the third and fifth pistons 16, 18 capable of pushing the first pad 12 toward the brake-disc-11 side to be respectively slidably fitted therein and have outer ends thereof closed by end walls 36a, 38a in a state wherein the third and fifth cylinder holes 36, 38 are arranged on both sides of the first cylinder hole 34. The third and fifth cylinder holes 36, 38 are formed longer than the first cylinder hole 34. Further, the third and fifth oil pressure chambers 45, 47 are formed between the end walls 36a, 38a of the third and fifth cylinder holes 36, 38 and the third and fifth pistons 16, 18.

Further, in the second body 28, fourth and sixth cylinder holes 37, 39 are formed having both ends thereof opened for allowing the fourth and sixth pistons 17, 19 capable of pushing the second pad 13 toward the brake-disc-11 side to be slidably fitted therein on both sides of the second cylinder hole 35 coaxially with the third and fifth cylinder holes 36, 38. Outer ends of the fourth and sixth cylinder holes 37, 39 are respectively fluid-tightly closed by second and third closing members 41, 42 which are threadedly engaged with the second body 28, for example. A fourth oil pressure chamber 46 is formed between the fourth piston 17 and the second closing member 41, and a sixth oil pressure chamber 48 is formed between the sixth piston 19 and the third closing member 42.

The first and second oil pressure chamber 43, 44 are in communication with each other by way of a first oil passage 50. As explicitly shown in FIG. 5, the first oil passage 50 is formed in the first body 27, the second body 28 and the first connection portion 29 so as to make a plurality of oil holes in communication with each other. A first connection hole 51, which opens at an outer surface of an outer side of the first body 27 along the radial direction of the brake disc 11, is formed in the first body 27 in a state wherein the first connection hole 51 is in communication with the first oil passage 50, and the first connection hole 51 is connected to the first master cylinder 22.

Further, in the first body 27, a first bleed hole 57 is formed that is in communication with the first oil pressure chamber 43 and opens at the outer surface of the outer side of the first body 27 on one side of the first connection hole 51. A lid member 58, which fluid-tightly closes an outer end of the first bleed hole 57, is detachably mounted on the first body 27 by threading or the like.

The third to sixth oil pressure chambers 45 to 48 are in communication with each other by way of the second oil passage 52. The second oil passage 52 is formed of a first body 27 side oil passage 52a is formed in the first body 27 in an extending manner along outside of the first oil pressure chamber 43 to make the third and fifth oil pressure chambers 45, 47 communicate with each other. A second body 28 side oil passage 52b is formed in the second body 28 in an extending manner along outside or inside (in this embodiment, inside) of the first closing member 40 of the second cylinder hole 35 along the radial direction of the brake disc 11 to make the fourth and sixth oil pressure chambers 46, 48 communicate with each other. A communication oil passage 52c is formed in either one of the second and third connection portions 30, 31 (in this embodiment, the third connection portion 31) to connect the first body 27 side oil passage 52a and the second body side oil passage 52b with each other.

The first body side oil passage 52a is formed in the first body 27 in a linearly extending manner to connect the third and fifth oil pressure chambers 45, 47 while traversing the first oil pressure chamber 43 as viewed in a side view. The second body side oil passage 52b is formed in the second body 28 in a linearly extending manner in parallel with the first body side oil passage 52a.

A second bleed hole 59 is formed in the first body 27 in a state wherein the second bleed hole 59 extends coaxially with the first body side oil passage 52a of the second oil passage 52, is in communication with the third oil pressure chamber 45 and, at the same time, is opened at the outer surface of the first body 27. A lid member 60 which fluid-tightly closes an outer end of the second bleed hole 59 is detachably mounted on the first body 27 by threading or the like.

Further, a second connection hole 53 which opens at the outer surface of the outer side of the first body 27 along the radial direction of the brake disc 11 is formed in the first body 27 such that the second connection hole 53 is in communication with the third oil pressure chamber 45, and the second master cylinder 24 is connected to the second connection hole 53.

The caliper body 20 is fixed to a vehicle body not shown in the drawing. In a connecting portion of the second and third connection portions 30, 31 and the first body 27, mounting holes 54, 55 are formed which are provided for mounting the caliper body 20 on the vehicle body side, respectively. Further, the communication oil passage 52c is formed in the third connection portion 31 so as to make a plurality of oil holes communicate with each other. As shown in FIG. 2, the communication oil passage 52c is formed in the third connection portion 31 in an extending manner along the outside of the mounting hole 55 formed in the connecting portion of the third connection portion 31 to the first body 27 to make the first and second body side oil passages 52a, 52b communicate with each other.

The manner of operation of this embodiment is explained. The first oil passage 50 which makes the first and second oil pressure chambers 43, 44 communicate with each other and the second oil passage 52 which makes the third, fourth, fifth and sixth oil pressure chambers 45 to 48 communicate with each other are formed in the inside of the caliper body 20. Thus, it becomes unnecessary to connect the first and second bodies 27, 28 by a conduit which is arranged outside the caliper body 20 so as to introduce an oil pressure. Accordingly, the miniaturization of the disc brake B can be realized and, at the same time, merchantability of the motorcycle can be enhanced due to the simplification of an appearance shape of the disc brake.

Further, the caliper body 20 is integrally formed of the first and second bodies 27, 28 and the first to third connection portions 29, 30, 31 which connect the first and second bodies 27, 28 and strides over the disc brake B. Thus, it is possible to reduce the number of parts and, at the same time, to save time and efforts for assembling the caliper body 20 to realize a reduction in the weight of the caliper body 20.

Further, by effectively making use of the first connection portion 29 which connects the center portions of the first and second bodies 27, 28 along the circumferential direction of the brake disc 11, it is possible to form the first oil passage 50 which makes the first and second oil pressure chambers 43, 44 arranged on the center portions of the first and second bodies 27, 28 along the circumferential direction of the brake disc 11 communicate with each other.

Further, the second oil passage 52 which makes the third to sixth oil pressure chambers 45 to 48 communicate with each other is formed of the first body side oil passage 52a which is formed in the first body 27 to make the third and fifth oil pressure chambers 45, 47 communicate with each other. The second body side oil passage 52b is formed in the second body 28 to make the fourth and sixth oil pressure chambers 46, 48 communicate with each other. A communication oil passage 52c is formed in either one of the second and third connection portions 30, 31 to connect the first body side oil passage 52a and the second body side oil passage 52b with each other. By effectively making use of either one of the second and third connection portions 30, 31, it is possible to form the second oil passage 52 which is formed in a substantially U shape as viewed in a plan view in the inside of the caliper body 20.

Further, out of the second oil passage 52, the first body side oil passage 52a which is formed in the first body 27 extends outside the first cylinder hole 34 which is formed shorter than the third and fifth cylinder holes 36, 38 to make the third and fifth oil pressure chambers 45, 47 communicate with each other. Out of the second oil passage 52, the second body side oil passage 52b which is formed in the second body 28 extends outside or inside (in this embodiment, inside) the first closing member 40 along the radial direction of the brake disc 11 while avoiding the interference with the first closing member 40 which closes the outer end of the second cylinder hole 35 and makes the fourth and sixth oil pressure chambers 46, 48 communicate with each other. Accordingly, it is possible to prevent the first and second bodies 27, 28 from becoming large-sized due to the formation of the first body side oil passage 52a and the second body side oil passage 52b.

Further, the communication oil passage 52c which connects the first and second body side oil passages 52a, 52b is formed in the third connection portion 31 in an extending manner outside the mounting hole 55 for mounting the caliper body 20 on the vehicle body side. Thus, it becomes unnecessary to provide a conduit which is arranged outside the caliper body 20 for connecting the first and second body side oil passages 52a, 52b. Accordingly, it is possible to simplify the appearance shape of the caliper body 20 thus enhancing the merchantability.

Further, the disc brake B is mounted on the front wheel of the motorcycle such that the first master cylinder 22 which generates an oil pressure in response to the manipulation of the brake lever 21 is connected to the first oil passage 50. At the same time, the second master cylinder 24 which generates an oil pressure in response to the manipulation of the brake pedal 23 is connected to the second oil passage 52. Thus, it is possible to preferably use the disc brake B of the present invention in the front and rear interlocking brake devices of a motorcycle.

Although the embodiment of the present invention has been explained heretofore, the present invention is not limited to the above-mentioned embodiment, and various modifications are conceivable in design without departing from the present invention described in claims.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A disc brake comprising:
a caliper body having first and second bodies for sandwiching a pair of pads arranged on both sides of a brake disc rotated with a wheel between the first and second bodies and the brake disc;
first and second pistons capable of pushing both pads toward the brake disc side, said first and second pistons being fitted in the first and second bodies coaxially and slidably;
third and fourth pistons capable of pushing both pads toward the brake disc side, said third and fourth pistons being fitted in the first and second bodies coaxially and slidably on one sides of the first and second pistons along the circumferential direction of the brake disc; and
fifth and sixth pistons capable of pushing both pads toward the brake disc side, said fifth and sixth pistons being fitted in the first and second bodies coaxially and slidably on another sides of the first and second pistons along the circumferential direction of the brake disc, said first and second pistons being interlockingly operated with each other, and the third to sixth pistons being interlockingly operated;
wherein inside of the caliper body, a first oil passage is formed for making first and second oil pressure chambers respectively facing back surfaces of the first and second pistons communicate with each other, and a second oil passage is formed for making third, fourth, fifth and sixth oil pressure chambers respectively facing back surfaces of the third to sixth pistons communicate with each other.

2. The disc brake according to claim 1, wherein the caliper body integrally includes a first connection portion for connecting center portions of the first and second bodies along the circumferential direction of the brake disc and strides over the brake disc and second and third connection portions for connecting both end portions of the first and second bodies along the circumferential direction of the brake disc and stride over the brake disc, said first oil passage being formed in the first body, the second body and the first connection portion.

3. The disc brake according to claim 2, wherein the second oil passage is formed of a first body side oil passage formed in the first body to make the third and fifth oil pressure chambers communicate with each other, a second body side oil passage is formed in the second body to make the fourth and sixth oil pressure chambers communicate with each other, and a communication oil passage is formed in either one of the second and third connection portions to connect the first body side oil passage and the second body side oil passage with each other.

4. The disc brake according to claim 3, wherein the first body includes a first cylinder hole having a bottom and allowing the first piston to be slidably fitted therein and an outer end thereof closed by an end wall forming the first oil pressure chamber between the first piston and the end wall, and third and fifth cylinder holes include bottoms formed longer than the first cylinder hole and are arranged on both sides of the first cylinder hole, for allowing the third and fifth pistons to be respectively slidably fitted therein, and have outer ends thereof closed by end walls which respectively form the third and fifth oil pressure chambers between the third and fifth pistons and the end walls; and
in the second body, second, fourth and sixth cylinder holes are formed having both ends thereof opened and allowing the second, fourth and sixth pistons to be slidably fitted therein are formed,
closing members for closing outer ends of the second, fourth and sixth cylinder holes are mounted on the second body such that the second, fourth and sixth oil pressure chambers are formed between the second, fourth and sixth pistons and the closing members and the first body side oil passage of the second oil passage is formed in the first body in a linearly extending manner along outside of the first oil pressure chamber along the axial direction of the first cylinder hole to make the third and fifth oil pressure chambers communicate with each other, and the second body side oil passage of the second oil passage is formed in the second body in a linearly extending manner along an outside or an inside of the closing member of the second cylinder hole along the radial direction of the brake disc to make the fourth and sixth oil pressure chambers communicate with each other.

5. The disc brake according to claim 3, wherein the communication oil passage of the second oil passage is formed in either one of the second and third connection portions to connect the first and second body side oil passages with each other along an outside of a mounting hole for mounting the caliper body on a vehicle body side.

6. The disc brake according to claim 4, wherein the communication oil passage of the second oil passage is formed in either one of the second and third connection portions to connect the first and second body side oil passages with each other along an outside of a mounting hole for mounting the caliper body on a vehicle body side.

7. The disc brake according to claim 1, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

8. The disc brake according to claim 2, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

9. The disc brake according to claim 3, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

10. The disc brake according to claim 4, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

11. The disc brake according to claim 5, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

12. A disc brake comprising:
a caliper body having first and second bodies for sandwiching a pair of pads arranged on both sides of a brake disc rotated with a wheel between the first and second bodies and the brake disc;
first and second pistons operatively connected to both pads for supplying a movement toward the brake disc side, said first and second pistons being fitted in the first and second bodies coaxially and slidably;
third and fourth pistons operatively connected to both pads for supplying a movement toward the brake disc side, said third and fourth pistons being fitted in the first and second bodies coaxially and slidably on one sides of the first and second pistons along the circumferential direction of the brake disc;
fifth and sixth pistons operatively connected to both pads for supplying a movement toward the brake disc side, said fifth and sixth pistons being fitted in the first and second bodies coaxially and slidably on another sides of the first and second pistons along the circumferential direction of the brake disc, said first and second pistons being interlockingly operated with each other, and the third to sixth pistons being interlockingly operated;
a first oil passage being formed within the caliper body for making first and second oil pressure chambers respectively facing back surfaces of the first and second pistons communicate with each other; and
a second oil passage being formed within the caliper body for making third, fourth, fifth and sixth oil pressure chambers respectively facing back surfaces of the third to sixth pistons communicate with each other.

13. The disc brake according to claim 12, wherein the caliper body integrally includes a first connection portion for connecting center portions of the first and second bodies along the circumferential direction of the brake disc and strides over the brake disc and second and third connection portions for connecting both end portions of the first and second bodies along the circumferential direction of the brake disc and stride over the brake disc, said first oil passage being formed in the first body, the second body and the first connection portion.

14. The disc brake according to claim 13, wherein the second oil passage is formed of a first body side oil passage formed in the first body to make the third and fifth oil pressure chambers communicate with each other, a second body side oil passage is formed in the second body to make the fourth and sixth oil pressure chambers communicate with each other, and a communication oil passage is formed in either one of the second and third connection portions to connect the first body side oil passage and the second body side oil passage with each other.

15. The disc brake according to claim 14, wherein the first body includes a first cylinder hole having a bottom and allowing the first piston to be slidably fitted therein and an outer end thereof closed by an end wall forming the first oil pressure chamber between the first piston and the end wall, and third and fifth cylinder holes include bottoms formed longer than the first cylinder hole and are arranged on both sides of the first cylinder hole, for allowing the third and fifth pistons to be respectively slidably fitted therein, and have outer ends thereof closed by end walls which respectively form the third and fifth oil pressure chambers between the third and fifth pistons and the end walls; and
in the second body, second, fourth and sixth cylinder holes are formed having both ends thereof opened and allowing the second, fourth and sixth pistons to be slidably fitted therein are formed,
closing members for closing outer ends of the second, fourth and sixth cylinder holes are mounted on the second body such that the second, fourth and sixth oil pressure chambers are formed between the second, fourth and sixth pistons and the closing members and the first body side oil passage of the second oil passage is formed in the first body in a linearly extending manner along outside of the first oil pressure chamber along the axial direction of the first cylinder hole to make the third and fifth oil pressure chambers communicate with each other, and the second body side oil passage of the second oil passage is formed in the second body in a linearly extending manner along an outside or an inside of the closing member of the second cylinder hole along the radial direction of the brake disc to make the fourth and sixth oil pressure chambers communicate with each other.

16. The disc brake according to claim 14, wherein the communication oil passage of the second oil passage is formed in either one of the second and third connection portions to connect the first and second body side oil passages with each other along an outside of a mounting hole for mounting the caliper body on a vehicle body side.

17. The disc brake according to claim 15, wherein the communication oil passage of the second oil passage is formed in either one of the second and third connection portions to connect the first and second body side oil passages with each other along an outside of a mounting hole for mounting the caliper body on a vehicle body side.

18. The disc brake according to claim 12, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

19. The disc brake according to claim 13, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage.

20. The disc brake according to claim 14, wherein the disc brake is mounted on a front wheel of a motorcycle such that a first master cylinder for generating an oil pressure in response to a manipulation of a first brake manipulation member is connected to the second oil passage, and a second master cylinder for generating an oil pressure in response to a manipulation of a second brake manipulation member is connected to the first oil passage
